(19) United States
(12) Patent Application Publication
(10) Pub. No.: US 2021/0062739 A1
(43) Pub. Date: Mar. 4, 2021

(54) EVAPORATED FUEL TREATMENT APPARATUS

(71) Applicant: AISAN KOGYO KABUSHIKI KAISHA, Obu-shi (JP)

(72) Inventors: Masanobu Shinagawa, Nagoya-shi (JP); Yoshikazu Miyabe, Obu-shi (JP)

(73) Assignee: AISAN KOGYO KABUSHIKI KAISHA, Obu-shi (JP)

(21) Appl. No.: 16/990,226

(22) Filed: Aug. 11, 2020

(30) Foreign Application Priority Data
Aug. 30, 2019 (JP) 2019-157993

(51) Int. Cl. F02D 41/00; F02M 25/08; B01D 53/04

(52) U.S. Cl. CPC F02D 41/0032; F02M 25/0854; F02M 25/0836; F02M 25/0809; B01D 53/0446; B01D 53/0454; B01D 2259/4516; B01D 2253/102; B01D 2257/702; B01D 2259/40086; B01D 2259/402; B01D 2259/41; F02M 2025/0845

(57) ABSTRACT

An evaporated fuel treatment apparatus includes a partition wall for dividing the inside of a canister into a first region located close to a purge passage and a fuel tank and a second region located close to an atmosphere passage, an electromagnetic valve provided in the partition wall and configured to open and close between the first and second regions, a small hole provided in the partition wall to release the pressure between the first and second regions, and a determination unit for performing a leak determination of the apparatus and a failure determination of a purge valve and the electromagnetic valve based on behaviors of the internal pressure of the canister according to opening and closing operations of the electromagnetic valve.

### CROSS-REFERENCE TO RELATED APPLICATIONS

This application is based upon and claims the benefit of priority from the prior Japanese Patent Applications No. 2019-157993 filed on Aug. 30, 2019, the entire contents of which are incorporated herein by reference.

### BACKGROUND

### Technical field

The present disclosure relates to an evaporated fuel treatment apparatus for treatment to introduce evaporated fuel generated in a fuel tank into an engine.

### Related Art

Improvement of fuel consumption reduces the frequency of driving an engine, leading to a reduced opportunity to purge a canister under engine negative pressure. This causes an increase in the amount of fuel (i.e., hydrocarbon (HC)) remaining in activated carbon in the canister. Thus, the amount of fuel to be released from the canister through its atmosphere port is apt to increase while a vehicle is parked, that is, during parking. Some countermeasures against such a defect are conceivable; for example, high-performance activated carbon is used in the canister or another canister is additionally provided in the outside of the atmosphere port. However, these countermeasures may lead to increased cost of the apparatus and increased size of the canister.

As one of conventional arts related to an evaporated fuel treatment apparatus equipped with the above-mentioned canister, U.S. Pat. No. 6,537,354 discloses an evaporated fuel treatment apparatus for a vehicle in which an on-off valve is provided on a partition wall located on an upstream side (a purge port side) of at least an adsorbent layer positioned closest to an atmosphere port.

### SUMMARY

### Technical Problems

However, U.S. Pat. No. 6,537,354 does not provide any disclosures about a leak determination of an apparatus and a failure determination of a valve. In U.S. Pat. No. 6,537,354, furthermore, when the pressure of a fuel tank excessively changes (rises or drops) while the on-off valve is closed, components of the apparatus, such as a canister, may not be protected.

The present disclosure has been made to address the above problems and has a purpose to provide an evaporated fuel treatment apparatus capable of reducing the amount of evaporated fuel to be released to the atmosphere during parking and further addressing a request of a vehicle, such as a purge control, a leak determination of an apparatus, and a failure determination of a valve, and also protecting components of the apparatus.

### Means of Solving the Problems

To achieve the above-mentioned purpose, one aspect of the present disclosure provides an evaporated fuel treatment apparatus comprising: a canister connected to a fuel tank and provided with a plurality of adsorption layers for adsorbing evaporated fuel generated in the fuel tank; a purge passage configured to allow purge gas containing the evaporated fuel to flow from the canister to an engine; a purge valve configured to open and close the purge passage; an atmosphere passage configured to take atmospheric air into the canister; a controller configured to perform purge control by placing the purge valve in an open state to introduce the purge gas from the canister into the engine through the purge passage; a partition wall dividing an inside of the canister into a first region located close to the purge passage and the fuel tank and a second region located close to the atmosphere passage; an electromagnetic valve provided in the partition wall and configured to open and close between the first region and the second region; a relief part provided in the partition wall and configured to release pressure between the first region and the second region; and a determination unit configured to perform a leak determination of the apparatus and a failure determination of the purge valve and the electromagnetic valve based on behaviors of internal pressure of the canister according to an opening and closing operation of the electromagnetic valve.

According the above aspect, while a vehicle equipped with the evaporated fuel treatment apparatus is parked, the electromagnetic valve is placed in a closed state, thereby preventing the evaporated fuel from diffusing or spreading from the first region located close to the purge passage and the fuel tank into the second region located close to the atmosphere passage. Thus, the evaporated fuel is less likely to diffuse from the second region into the atmosphere passage. This can reduce release of the evaporated fuel from the canister to the atmosphere through the atmosphere passage during parking.

In contrast, when the purge control is to be executed, the electromagnetic valve is placed in an open state, thereby enabling communication between the first region and the second region to allow purge gas to flow within the canister. This can prevent an increase in pressure loss which may be caused by the electromagnetic valve if it is in a closed state which stops a flow of purge gas during execution of the purge control, and therefore avoid an insufficient flow rate of the purge gas.

Even when the pressure of the fuel tank excessively changes while the electromagnetic valve is in a closed state, the relief part allows pressure release between the first region and the second region, so that the pressure in the first region located close to the fuel tank is less likely to excessively change. Thus, components of the apparatus, including the canister, can be protected.

The above-mentioned evaporated fuel treatment apparatus can perform the leak determination of the apparatus and the failure determination of the purge valve and the electromagnetic valve by use of the electromagnetic valve.

Accordingly, the evaporated fuel treatment apparatus configured as above can suppress the evaporated fuel from releasing to the atmosphere during parking of a vehicle and further address a request of the vehicle, such as the purge control, the leak determination of the apparatus, and the failure determination of the valve, and also can protect components of the apparatus.

### BRIEF DESCRIPTION OF THE DRAWINGS

FIG. 1 is an entire configuration diagram of an evaporated fuel treatment apparatus in a first embodiment, showing a state of the apparatus while a purge control is not executed;

FIG. 2 is an entire configuration diagram of the evaporated fuel treatment apparatus in the first embodiment, showing a state of the apparatus while the purge control is being executed;

FIG. 3 is a time chart in Example 1 of the first embodiment;

FIG. 4 is a diagram showing that an electromagnetic valve is placed in an open state in advance of start of the purge control;

FIG. 5 is a time chart in Example 2 of the first embodiment;

FIG. 6 is an entire configuration diagram of an evaporated fuel treatment apparatus in Examples 1 and 2 of a second embodiment, showing a state of the apparatus for preliminary diagnosis;

FIG. 7 is a flowchart showing control details of a determination method in Example 1 of the second embodiment;

FIG. 8 is a diagram showing a state of the apparatus for primary determination;

FIG. 9 is a diagram showing a state of the apparatus for secondary determination;

FIG. 10 is a time chart in Example 1 of the second embodiment;

FIG. 11 is a flowchart showing control details of a determination method in Example 2 of the second embodiment;

FIG. 12 is a time chart in Example 2 of the second embodiment;

FIG. 13 is an entire configuration diagram of an evaporated fuel treatment apparatus in Examples 3 and 4 of the second embodiment, showing a state of the apparatus for preliminary diagnosis;

FIG. 14 is a diagram showing a state of the apparatus for primary determination;

FIG. 15 is a diagram showing a state of the apparatus for secondary determination;

FIG. 16 is a time chart in Example 3 of the second embodiment;

FIG. 17 is a time chart in Example 4 of the second embodiment;

FIG. 18 is an entire configuration diagram of an evaporated fuel treatment apparatus in Examples 5 and 6 of the second embodiment, showing a state of the apparatus for preliminary diagnosis;

FIG. 19 is a diagram showing a state of the apparatus for primary determination;

FIG. 20 is a diagram showing a state of the apparatus for secondary determination;

FIG. 21 is a time chart in Example 5 of the second embodiment;

FIG. 22 is a time chart in Example 6 of the second embodiment;

FIG. 23 is an entire configuration diagram of an evaporated fuel treatment apparatus in Example 1 of the third embodiment, showing a state of the apparatus for leak determination;

FIG. 24 is a diagram showing a state of the apparatus for failure determination of an electromagnetic valve;

FIG. 25 is a time chart in Example 1 of the third embodiment;

FIG. 26 is a graph showing details of a method for determining whether or not the electromagnetic valve is in an open failure and a small hole is in a close failure;

FIG. 27 is an entire configuration diagram of an evaporated fuel treatment apparatus in Example 2 of the third embodiment, showing a state of the apparatus for leak determination;

FIG. 28 is a diagram showing a state of the apparatus for failure determination of the electromagnetic valve;

FIG. 29 is a time chart in Example 2 of the third embodiment;

FIG. 30 is a diagram showing components related to the evaporated fuel treatment apparatus and refueling;

FIG. 31 is a flowchart showing control details during refueling;

FIG. 32 is a time chart showing control details during refueling; and

FIG. 33 is an entire configuration diagram of another example of the evaporated fuel treatment apparatus shown in FIG. 1.

### DETAILED DESCRIPTION OF THE EXEMPLARY EMBODIMENTS

A detailed description of embodiments of an evaporated fuel treatment apparatus according to the present disclosure will now be given referring to the accompanying drawings. In the embodiments described below, the evaporated fuel treatment apparatus of the present disclosure is applied to an engine system to be mounted in a vehicle, such as a car.

### First Embodiment

The first embodiment will be described blow.

<Outline of Evaporated fuel treatment apparatus>

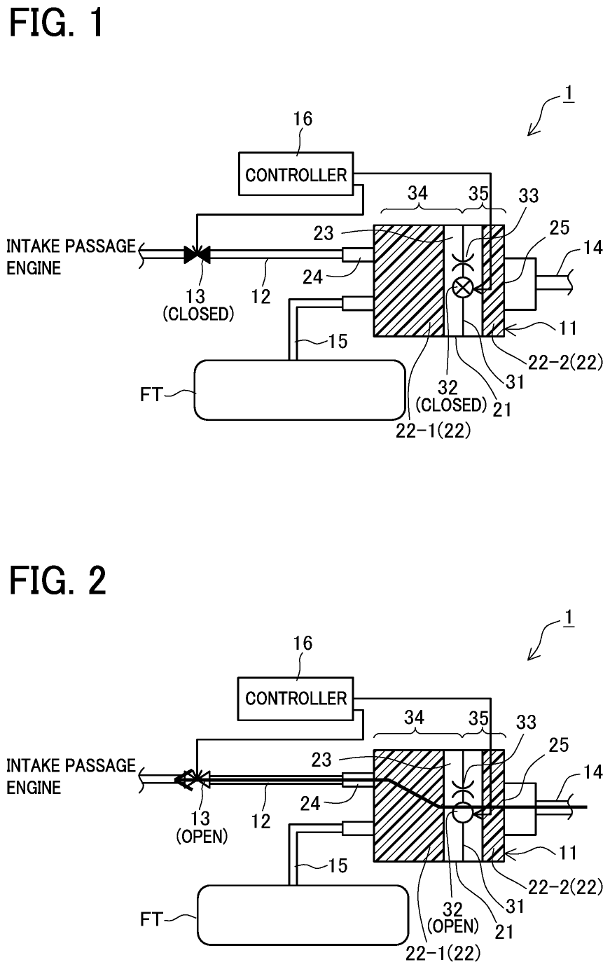

An evaporated fuel treatment apparatus 1 in the present embodiment is an apparatus configured to introduce evaporated fuel generated in a fuel tank FT into an engine (not shown) through an intake passage (not shown). This evaporated fuel treatment apparatus 1 includes a canister 11, a purge passage 12, a purge valve 13, an atmosphere passage 14, a vapor passage 15, a controller 16, and others, as shown in FIGS. 1 and 2.

The canister 11 is connected to the fuel tank FT through the vapor passage 15 and configured to temporarily store evaporated fuel flowing therein from the fuel tank FT through the vapor passage 15. The canister 11 communicates with the purge passage 12 and also with the atmosphere passage 14.

The canister 11 is provided with a canister case 21, activated carbons 22 (one example of an adsorption layer of the present disclosure), and space chambers 23.

The canister case 21 is a container for storing evaporated fuel flowing therein from the fuel tank FT through the vapor passage 15. This canister case 21 is provided with a purge port 24 and an atmosphere port 25. The purge port 24 is an outlet port to allow purge gas (i.e., the gas containing purge air (that is, atmospheric air) and evaporated fuel) to flow out of the canister case 21. The atmosphere port 25 is an inlet port to allow purge air to flow into the canister case 21 from the atmosphere.

The activated carbon 22 is an adsorbent capable of adsorbing thereon evaporated fuel generated in the fuel tank FT. This activated carbon 22 is provided in a plurality of layers in the canister case 21. In this embodiment, as one example, the activated carbon 22 is provided in two layers in the canister case 21. Specifically, these two layers of the activated carbon 22 include a first layer of activated carbon (“first-layer activated carbon”) 22-1 and a second-layer activated carbon 22-2, which are arranged in this order in the canister case 21 from a position close to the purge port 24 to a position close to the atmosphere port 25.

The space chamber 23 is a space region formed in the canister case 21. In the present embodiment, the space chamber 23 is provided between the first-layer activated carbon 22-1 and the second-layer activated carbon 22-2.

The purge passage 12 is connected to the intake passage and also to the canister 11. This configuration allows the purge gas that flows out of the canister 11, i.e., the gas containing evaporated fuel, to flow through the purge passage 12 into the intake passage. In other words, the purge passage 12 is a channel for allowing a purge gas to be introduced from the canister 11 to the engine to flow.

The purge valve 13 is placed in the purge passage 12. This purge valve 13 is configured to open and close the purge passage 12. While the purge valve 13 is in a closed state, the purge gas in the purge passage 12 is shut off by the purge valve 13 from flowing to the intake passage. While the purge valve 13 is in an open state, on the other hand, the purge gas is allowed to flow into the intake passage.

The atmosphere passage 14 has one end that is open to the atmosphere and the other end that is connected to the canister 11 to permit the canister 11 to communicate with the atmosphere. The atmosphere passage 14 is configured to take atmospheric air into the canister 11. In other words, the atmosphere passage 14 is a channel for introducing atmospheric air into the canister 11.

The vapor passage 15 is connected to the fuel tank FT and also to the canister 11. This allows the evaporated fuel in the fuel tank FT to flow in the canister 11 through the vapor passage 15.

The controller 16 is a part of an ECU (not illustrated) mounted in a vehicle and placed integral with other parts of the ECU (e.g., parts for controlling the engine). This controller 16 may be provided separately from the other parts of the ECU. The controller 16 includes a CPU, a ROM, a RAM, and others. The controller 16 is configured to control the evaporated fuel treatment apparatus 1 and the engine system according to programs stored in advance in a memory. For instance, the controller 16 is configured to control the purge valve 13 and the electromagnetic valve 32 which will be mentioned later.

In the present embodiment, the canister 11 is provided with a partition wall 31, an electromagnetic valve 32, and a small hole 33 (one example of a relief part in the present disclosure) in the space chamber 23 between the first-layer activated carbon 22-1 and the second-layer activated carbon 22-2 in order to prevent diffusing or spreading of evaporated fuel between the first-layer activated carbon 22-1 and the second-layer activated carbon 22-2.

The partition wall 31 is provided to divide the inside of the canister 11 into a first region 34 and a second region 35 so that the first region 34 is located on a side close to the purge passage 12 and the fuel tank FT (i.e., the vapor passage 15) and the second region 35 is located on a side close to the atmosphere passage 14. The first region 34 is provided with the first-layer activated carbon 22-1 and the second region 35 is provided with the second-layer 22-2.

The electromagnetic valve 32 is provided in the partition wall 31 and configured to open and close between the first region 34 and the second region 35. This electromagnetic valve 32 is a normally-closed valve, i.e., a valve that is closed during non-energization. As an alternative, the electromagnetic valve 32 may be a valve that is driven by a stepping motor to open and close.

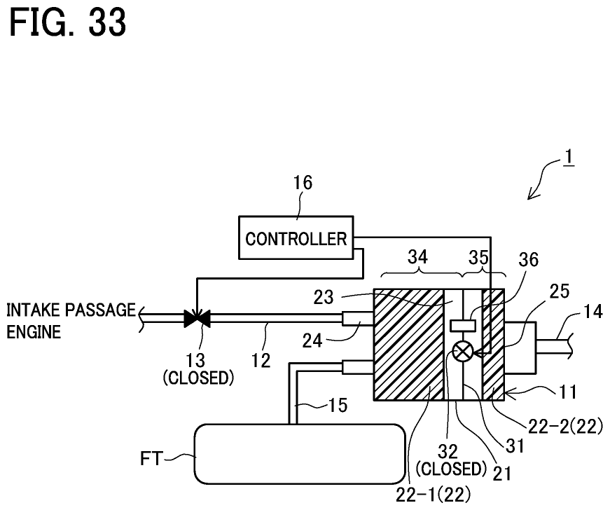

The small hole 33 is provided in the partition wall 31 and configured to allow communication between the first region 34 and the second region 35 to release the pressure between the first region 34 and the second region 35. This small hole 33 is a fixed aperture having a small, fixed aperture opening degree. As an alternative, instead of the small hole 33, a relief valve 36 may be installed as illustrated in FIG. 33 showing another example of the evaporated fuel treatment apparatus 1 shown in FIG. 1.

The canister 11 including the partition wall 31 and the electromagnetic valve 32 as configured above can reduce the quantity of evaporated fuel (i.e., HC) caused to move from the first-layer 22-1 to the second-layer activated carbon 22-2 due to diffusion. Accordingly, the diffusional quantity of evaporated fuel diffused from the second-layer activated carbon 22-2 to the atmosphere passage 14 can be reduced, thereby enabling a reduction in the release quantity of evaporated fuel released through the atmosphere port 25 of the canister 11 during parking.

In the evaporated fuel treatment apparatus 1 configured as above, when a purge condition is satisfied during operation of the engine, the controller 16 performs a purge control by placing the purge valve 13 in an open state to introduce purge gas from the canister 11 into the engine through the purge passage 12 and the intake passage under an engine negative pressure. The “engine negative pressure” represents the negative pressure generated in the purge passage 12 and the intake passage when the engine is driven.

At that time, concretely, the canister 11 is subjected to the following purge process, that is, a separation process of fuel adsorbed on the activated carbon 22. Firstly, purge air, i.e., atmospheric air, flows from the atmosphere into the second-layer activated carbon 22-2 through the atmosphere port 25, thereby causing separation of the fuel adsorbed on the second-layer activated carbon 22-2. Then, purge gas, i.e., a mixture gas of the purge air and evaporated fuel, flows from the second-layer activated carbon 22-2 into the first-layer activated carbon 22-1 through the space chamber 23, thereby causing separation of the fuel adsorbed on the first-layer activated carbon 22-1. Subsequently, the purge gas containing the fuel separated from the second-layer activated carbon 22-2 and the first-layer activated carbon 22-1 flows from the first-layer activated carbon 22-1 into the purge passage 12 through the purge port 24.

While the purge control is being executed, the engine is supplied with the air taken into the intake passage, the fuel injected from the fuel tank FT through an injector (not shown), and further the purge gas introduced into the intake passage under the purge control. The controller 16 is also configured to adjust the injection time of the injector, the opening time of the purge valve 13, and others to regulate an air-fuel ratio (A/F) of the engine to an optimum air-fuel ratio, for example, an ideal air-fuel ratio.

<Control of Electromagnetic Valve under Purge Control>

In the present embodiment, during execution of the purge control, the electromagnetic valve 32 is held in an open state, thereby allowing purge gas to flow within the canister 11. Therefore, the control of the electromagnetic valve 32 to perform the purge control will be described below.

### EXAMPLE 1

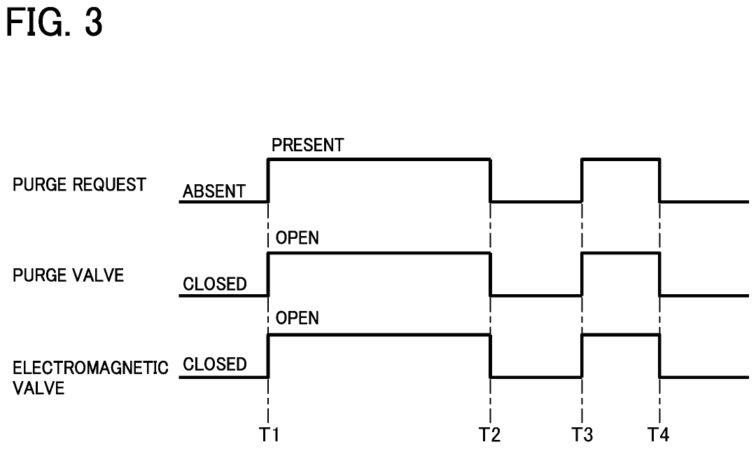

Example 1 is firstly described. In this Example, the controller 16 is configured to start the purge control and simultaneously place the electromagnetic valve 32 in an open state. Concretely, when a purge request is present at time T1 or T3, as shown in FIG. 3, the controller 16 turns the purge valve 13 to an open state and starts the purge control and concurrently turns the electromagnetic valve 32 to an open state to allow purge gas to flow within the canister 11. This can prevent an increase in pressure loss which may be caused by the electromagnetic valve 32 if it is in a closed state which blocks a flow of purge gas during execution of the purge control, and hence avoid an insufficient flow rate of purge gas.

In this Example, the electromagnetic valve 32 is a normally-closed valve. This electromagnetic valve 32 is not continuously energized when no purge request is given, and thus the electromagnetic valve 32 is held in a closed state. This configuration can prevent heat generation caused by continuous energization.

### EXAMPLE 2

Next, Example 2 will be described below. In this Example, the controller 16 is configured to predict the timing for performing the purge control based on vehicle information and turn the electromagnetic valve 32 to an open state at the time earlier by a predetermined time than the predicted timing. The controller 16 is one example of a purge predicting part of the present disclosure.

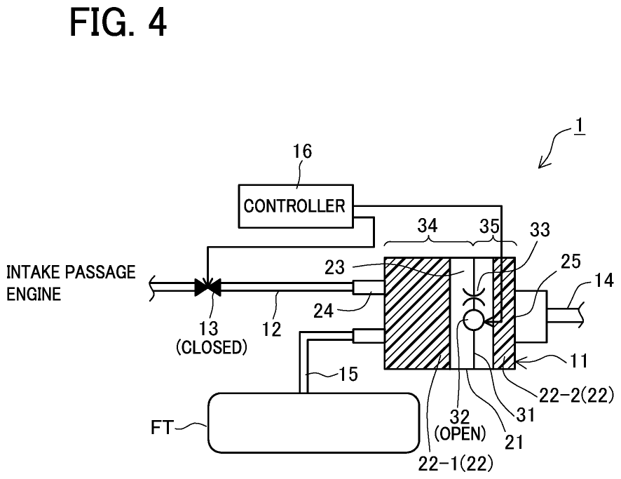

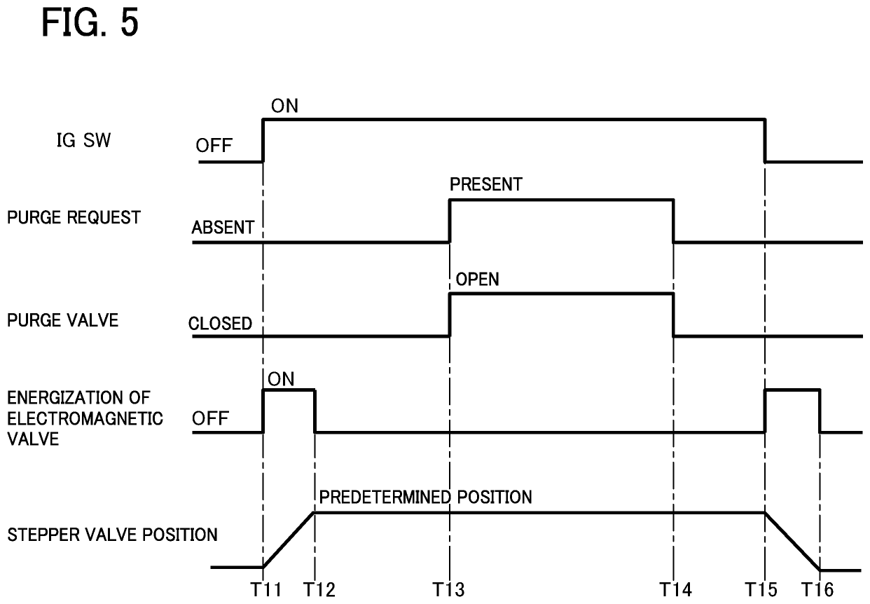

Concretely, as shown in FIGS. 4 and 5, when an ignition switch of a vehicle (expressed by “IG SW” in FIG. 5) is turned ON at time T11, the controller 16 turns ON the energization of the electromagnetic valve 32 (i.e., starts the energization thereof). As an alternative, the controller 16 may be configured to turn ON the energization of the electromagnetic valve 32 when the engine rotation number reaches a predetermined value or when a residual quantity of a battery (e.g., a fuel battery) becomes a predetermined value.

At time T12, the controller 16 subsequently maintains the electromagnetic valve 32 in the open state at a predetermined opening degree. At time T3, when a purge request is present, the controller 16 starts the purge control by placing the purge valve 13 in the open state. At that time, the electromagnetic valve 32 has already been in the open state.

In this Example, preferably, the electromagnetic valve 32 is a valve that is driven by a stepping motor to open and close. The controller 16 starts energization of the electromagnetic valve 32 at time T11, adjusts the step position of the stepping motor to a predetermined position at time T12, and keeps the electromagnetic valve 32 in the open state at the predetermined opening degree.

In this Example, the electromagnetic valve 32 is opened in advance of the start of the purge control. Thus, the electromagnetic valve 32 may have to be maintained in the open state over a long period before the start of the purge control. In this Example, however, the electromagnetic valve 32 is a valve that is driven by the stepping motor to open and close. If the step position of the stepping motor can be adjusted to the predetermined position, therefore, the electromagnetic valve 32 can be maintained in the open state at the predetermined opening degree during non-energization. Thus, the electromagnetic valve 32 does not need to be energized continuously for a long period, so that the heat generation of the electromagnetic valve 32 is suppressed.

### <Operations and Effects of Present Embodiment>

The evaporated fuel treatment apparatus 1 in the present embodiment includes the partition wall 31 to divide the inside of the canister 11 into the first region 34 and the second region 35 so that the first region 34 is located close to the purge passage 12 and the fuel tank FT and the second region 35 is located close to the atmosphere passage 14. The evaporated fuel treatment apparatus 1 further includes the electromagnetic valve 32 placed in the partition wall 31 and configured to open and close between the first region 34 and the second region 35, and the small hole 33 provided in the partition wall 31 and configured to release the pressure between the first region 34 and the second region 35.

Accordingly, during parking of a vehicle equipped with the evaporated fuel treatment apparatus 1, when the electromagnetic valve 32 is placed in a closed state, evaporated fuel is less likely to diffuse from the first-layer activated carbon 22-1 provided in the first region 34 located close to the purge passage 12 and the fuel tank FT to the second-layer activated carbon 22-2 provided in the second region 35 located close to the atmosphere passage 14. Thus, the evaporated fuel is unlikely to diffuse from the second-layer activated carbon 22-2 provided in the second region 35 to the atmosphere passage 14. This can prevent release of evaporated fuel from the canister 11 to the atmosphere through the atmosphere passage 14 during parking.

In contrast, when the purge control is performed, the electromagnetic valve 32 is placed in an open state. This allows the first region 34 and the second region 35 to communicate with each other, thereby enabling a flow of the purge gas within the canister 11. This can prevent an increase in pressure loss which may be caused by the electromagnetic valve 32 if it is in a closed state which blocks a flow of purge gas during purge control, and can avoid an insufficient flow rate of purge gas.

Moreover, even when the internal pressure of the fuel tank FT excessively changes while the electromagnetic valve 32 is in a closed state, the small hole 33 allows the pressure to release between the first region 34 and the second region 35, so that the pressure in the first region 34 located close to the fuel tank FT is less likely to excessively change. This makes it possible to protect the components of the apparatus including the canister 11, for example, the canister 11 communicating with the fuel tank FT, the electromagnetic valve 32, the purge passage 12, and the purge valve 13.

The evaporated fuel treatment apparatus 1 in the present embodiment configured as above can prevent the evaporated fuel from releasing to the atmosphere during parking, address a request of a vehicle, such as the purge control, and also protect the components of the apparatus.

Furthermore, the electromagnetic valve 32 is a normally-closed valve. Accordingly, while the electromagnetic valve 32 is in a closed state, this can save power and prevent heat generation.

The evaporated fuel treatment apparatus 1 in the present embodiment includes the controller 16 configured to predict the timing for performing the purge control based on vehicle information. This controller 16 turns the electromagnetic valve 32 to an open state at the time earlier by a predetermined time than the predicted timing for performing the purge control.

Accordingly, the electromagnetic valve 32 is placed in the open state in advance of the start of the purge control. Thus, the evaporated fuel treatment apparatus 1 enables the purge gas to flow within the canister 11 while preventing a delay in the timing to open the electromagnetic valve 32 when the purge control is started and further.

### Second Embodiment

A second embodiment will be described below, in which similar or identical parts or elements to those in the first embodiment are assigned the same reference signs as those in the first embodiment and their details are omitted. The following description is made with a focus on differences from the first embodiment.

### EXAMPLE 1

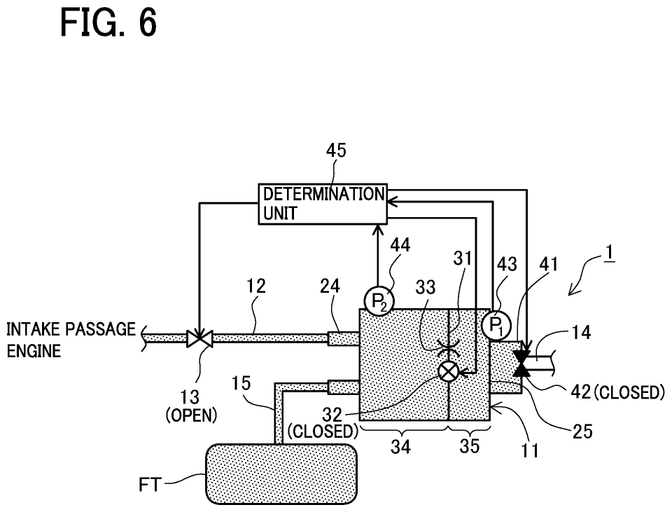

Example 1 will be described below. In this Example, as shown in FIG. 6, the evaporated fuel treatment apparatus 1 includes a key-off pump 41, a switching valve 42, and a pressure sensor 43 (i.e., a first pressure sensor). The evaporated fuel treatment apparatus 1 further includes a pressure sensor 44 (i.e., a second pressure sensor) and a determination unit 45 (which is also referred to as a “leak failure determination unit”). In FIG. 6, for ease of explanation, the activated carbon 22 and the space chamber 23 are not illustrated.

The key-off pump 41 is a pump provided at a connection of the canister 11 with the atmosphere port 14. The switching valve 42 is configured to open and close the atmosphere passage 14 and is a normally-open valve. The pressure sensor 43 is configured to detect the pressure in the second region 35 of the canister 11. The pressure sensor 44 is configured to detect the pressure in the first region 34 of the canister 11.

The determination unit 45 in this Example is configured to perform a leak determination of the apparatus (“apparatus leak determination”) and a failure determination of the purge valve 13 and the electromagnetic valve 32 (“valve failure determination”) based on behaviors of the pressure in the canister 11 according to the opening and closing operations of the electromagnetic valve 32 as will be described in detailed later. In this embodiment, the “apparatus leak determination” means a determination as to whether or not a leak exists in the apparatus, that is, whether or not gas (e.g., purge gas) is leaking in the canister 11 and its surroundings (e.g., the purge passage 12 and the vapor passage 15) in the evaporated fuel treatment apparatus 1. The determination unit 45 may be provided as a part of the controller 16 or provided separately from the controller 16.

In this Example, the determination unit 45 is configured to perform the apparatus leak determination and the valve failure determination based on detection values of the pressure sensor 43 and the pressure sensor 44 obtained when the electromagnetic valve 32 and the switching valve 42 are individually switched between an open state and a closed state during execution of the purge control. In this embodiment, the “valve failure determination” means a determination as to whether or not the purge valve 13, the electromagnetic valve 32, or the switching valve 42 has failed. The determination unit 45 is configured to perform the valve failure determination after executing the apparatus leak determination.

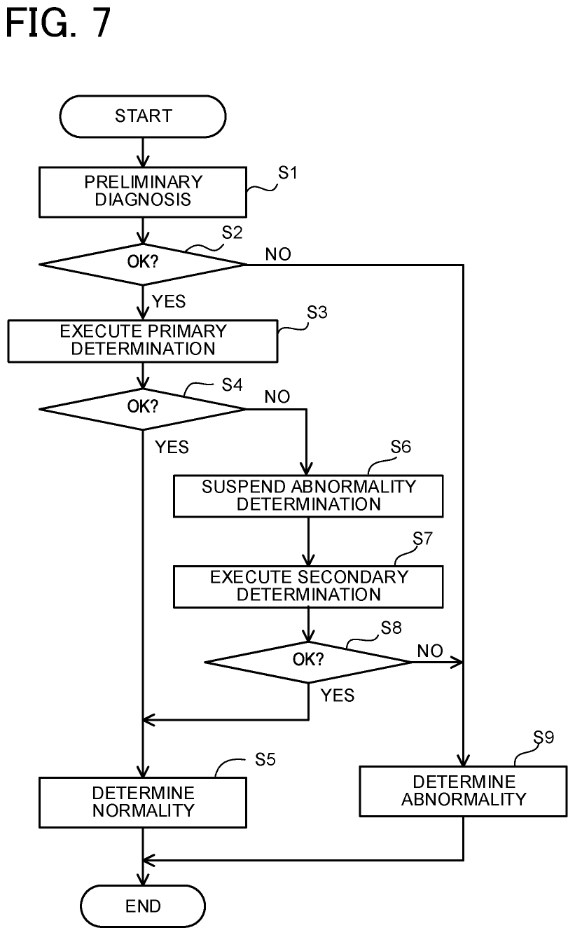

Concretely, as shown in FIG. 7, the determination unit 45 firstly performs a preliminary diagnosis (step S1).

In this preliminary diagnosis, the leak determination of the apparatus 1 and the failure determination of the purge valve 13 and the switching valve 42 are performed. Specifically, as shown in FIG. 6, during execution of the purge control, the determination unit 45 places the purge valve 13 in an open state and places the electromagnetic valve 32 and the switching valve 42 in a closed state. When a detection value of the pressure sensor 43 is less than a first determination value JVa, the determination unit 45 determines that the purge valve 13 is not in a close failure state, the switching valve 42 is not in an open failure state, and further that no apparatus leak has occurred, and thus judges that an affirmative result is obtained in the preliminary diagnosis. The first determination value JVa is a negative value. The “close failure” means a failure condition that a valve remains closed while it is controlled to open, that is, the valve fails to open. The “open failure” means a failure condition that a valve remains open while it is controlled to close, that is, the valve fails to close.

Returning to FIG. 7, when the result of the preliminary diagnosis is affirmative (step S2: YES), the determination unit 45 performs a primary determination (step S3).

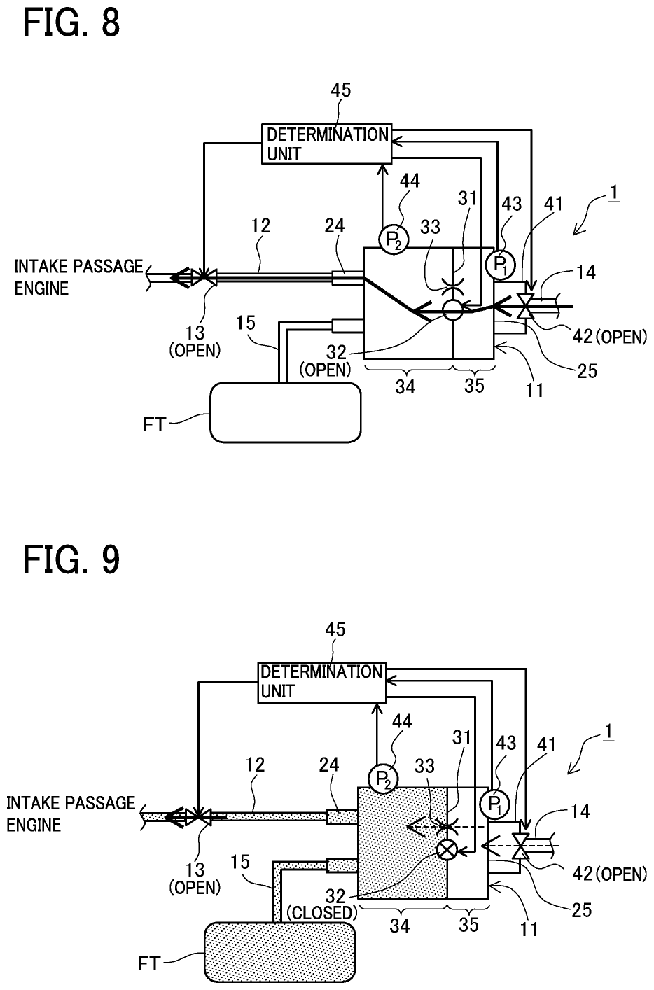

In this primary determination, the failure determination of the electromagnetic valve 32 is performed. Specifically, as shown in FIG. 8, the determination unit 45 places all of the purge valve 13, the electromagnetic valve 32, and the switching valve 42 in the open state during execution of the purge control. When the detection value of the pressure sensor 43 is less than a second determination value JVb, the determination unit 45 determines that the electromagnetic valve 32 is not in the close failure state and judges that the result of the primary determination is affirmative. The second determination value JVb is a pressure value (a pressure value on a positive pressure side) higher than the first determination value JVa.

Returning to FIG. 7, if the primary determination result is affirmative (step S4: YES), the determination unit 45 then determines the normality (Normality determination), that is, determines that the electromagnetic valve 32 is normal (step S5).

If the primary determination result in step S2 is negative (step S2: NO), the determination unit 45 then determines the abnormality (Abnormality determination), that is, determines that the the purge valve 13, the electromagnetic valve 32, or the switching valve 42_is abnormal (step S9).

If the primary determination result is negative in step S4 (step S4: NO), that is, if the detection value of the pressure sensor 43 is equal to or larger than the second determination value JVb, the determination unit 45 suspends the abnormality determination (step S6) and instead performs a secondary determination (step S7).

In this secondary determination, the failure determination of the electromagnetic valve 32 is performed. Specifically, as shown in FIG. 9, during execution of the purge control, the determination unit 45 holds the purge valve 13 in the open state, places the electromagnetic valve 32 in the closed state, and holds the switching valve 42 in the open state. In this state, the purge passage 12 is opened by the purge valve 13 in the open state, and the electromagnetic valve 32 is in the closed state, so that the pressure in the first region 34 of the canister 11 becomes negative due to the engine negative pressure.

However, gas (i.e., purge air or purge gas) is allowed to flow little by little from the second region 35 to the first region 34 through the small hole 33, and therefore the first region 34 is made to gradually comes under negative pressure. This causes a detection value of the pressure sensor 44 to gradually change to a negative value (that is, the pressure decreases). If a time Ta required for the detection value of the pressure sensor 44 to reach a predetermined pressure Pa falls within a specified range, therefore, the determination unit 45 determines that the electromagnetic valve 32 is not in a close failure state and judges that the result of the secondary determination is affirmative. The above predetermined pressure Pa is a negative pressure.

Returning to FIG. 7, if the secondary determination result is affirmative (step S8: YES), the determination unit 45 determines the normality (step S5). In contrast, if the secondary determination result is negative (step S8: NO), the determination unit 45 determines the abnormality (step S9).

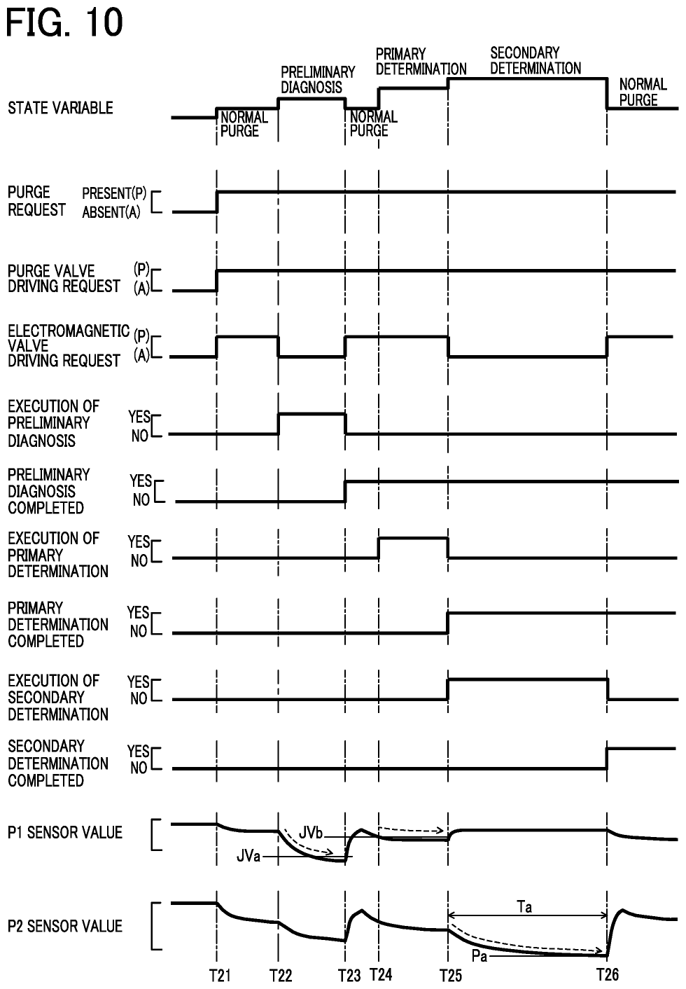

When the failure determination is executed based on such a flowchart as shown in FIG. 7, a time chart shown in FIG. 10 is carried out as one example. As shown in FIG. 10, when a purge request and a purge valve driving request are present at time T21, the purge valve 13 is turned to the open state and thus the purge control is started. At that time, when an electromagnetic valve driving request is present, the electromagnetic valve 32 is turned to the open state. The switching valve 42 remains open. Then, when the electromagnetic valve driving request is absent at time T22, the electromagnetic valve 32 is turned to the closed state. The switching valve 42 is also turned to the closed state. The preliminary diagnosis is thus performed. When the detection value of the pressure sensor 43 (expressed as “P1 sensor value” in FIG. 10) in this preliminary diagnosis becomes less than the first determination value JVa, the preliminary diagnosis is completed at time T23. At that time, the electromagnetic valve 32 and the switching valve 42 are turned to the open state.

Thereafter, the normal purge control is executed. At time T24, the primary determination is performed. When the detection value of the pressure sensor 43 in the primary determination is less than the second determination value JVb, the primary determination is completed and instead the secondary determination is started at time T25. At that time, the electromagnetic valve 32 is turned to the closed state. In this secondary determination, it is determined whether or not a time Ta required for the detection value of the pressure sensor 44 (expressed as “P2 sensor value” in FIG. 10) to reach the predetermined pressure Pa falls within the specified range. At time T26, the secondary determination is completed.

### EXAMPLE 2

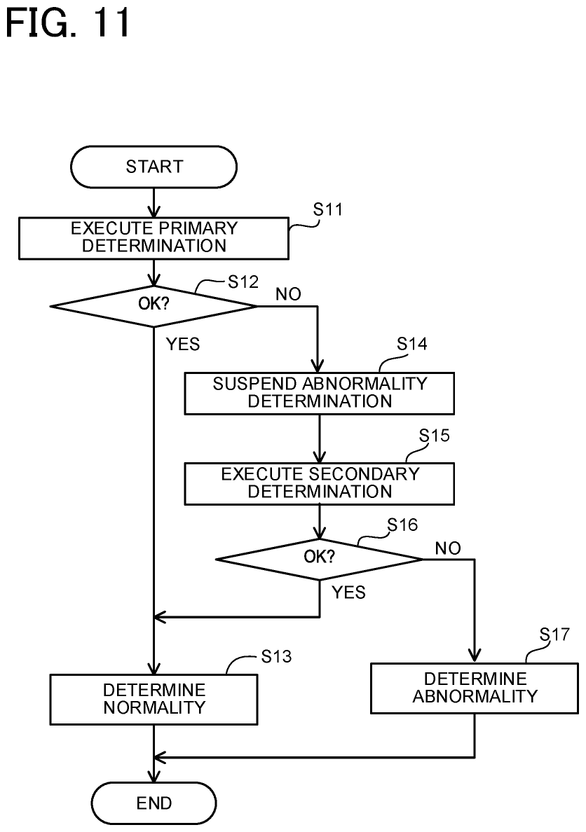

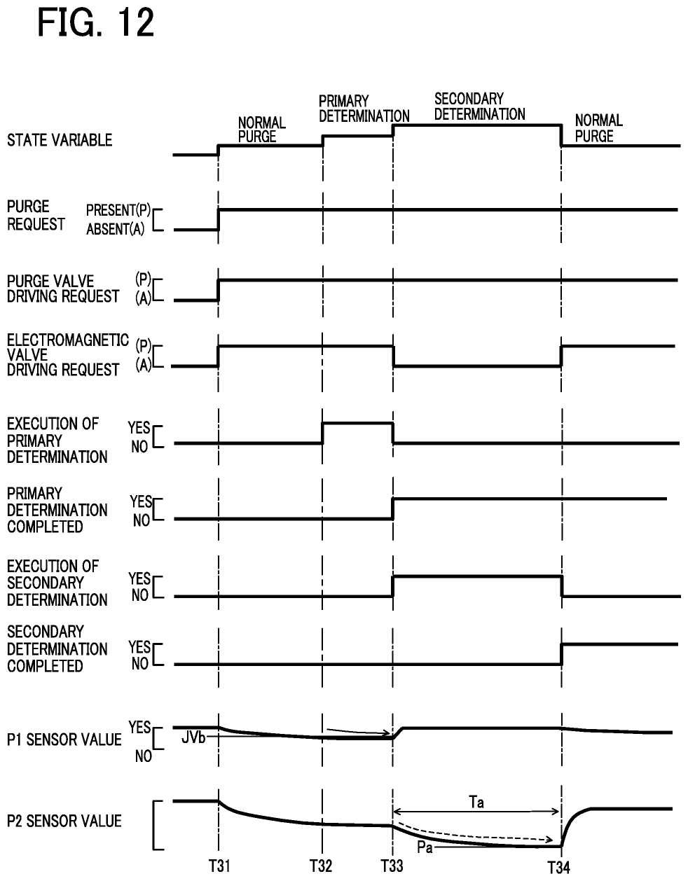

Example 2 will be described below. This Example exemplifies that execution of the preliminary diagnosis is unnecessary. Thus, differently from Example 1, the determination unit 45 in this Example is configured to perform the primary determination and the secondary determination as shown in FIGS. 11 and 12 without executing the preliminary diagnosis. The processing details in step S11 to step S17 shown in FIG. 11 are the same as those in step S3 to step S9 shown in FIG. 7 and therefore their description is omitted herein. Further, the processing details to be carried out at time T31 to time T34 shown in FIG. 12 are the same as those to be carried out at time T23 to time T26 shown in FIG. 10 and therefore their description is omitted herein.

### EXAMPLE 3

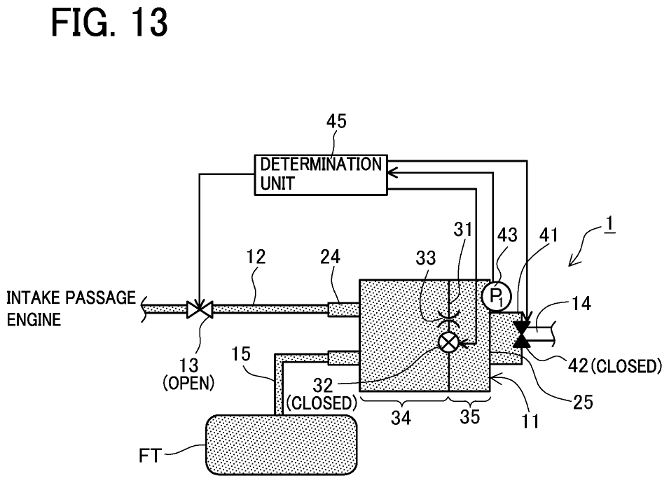

Example 3 will be described below. In this Example, as shown in FIG. 13, the evaporated fuel treatment apparatus 1 does not include the pressure sensor 44, but includes only the pressure sensor 43.

In this Example, the determination unit 45 is configured to perform the preliminary diagnosis, the primary determination, and the secondary determination in a similar manner to those in Example 1 as shown in FIG. 7.

In the preliminary diagnosis, herein, the apparatus leak determination and the failure determination of the purge valve 13 and the switching valve 42 are performed. Specifically, as shown in FIG. 13, during execution of the purge control, the determination unit 45 places the purge valve 13 in the open state and places the electromagnetic valve 32 and the switching valve 42 in the closed state. When the detection value of the pressure sensor 43 is less than the first determination value JVa, the determination unit 45 determines that the purge valve 13 is not in the close failure state, the switching valve 42 is not in the open failure state, and further no apparatus leak has occurred, and thus judges that the the result of the preliminary diagnosis is affirmative.

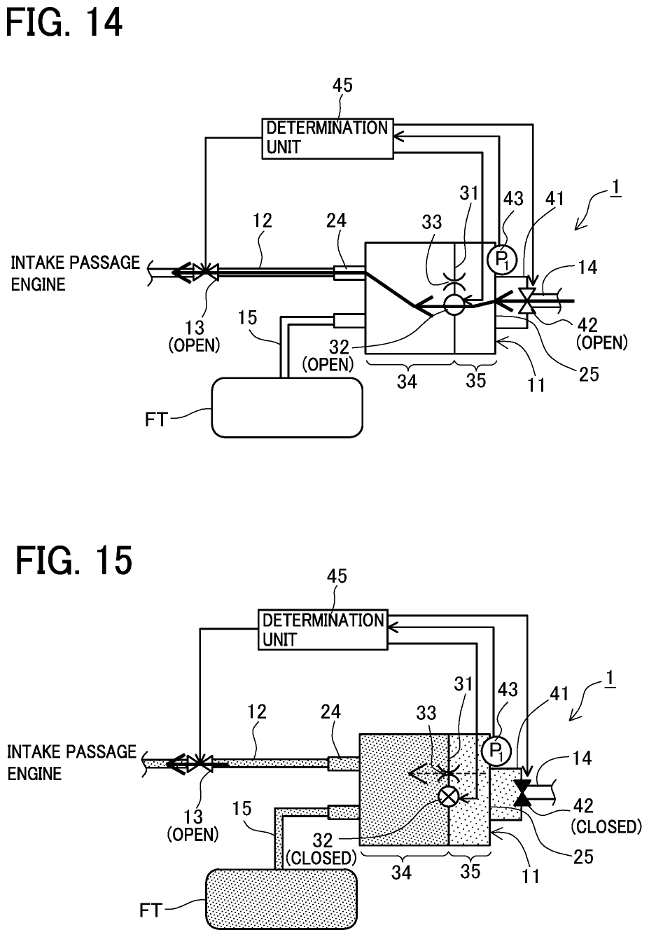

In the primary determination, as shown in FIG. 14, the determination unit 45 places all of the purge valve 13, the electromagnetic valve 32, and the switching valve 42 in the open state during execution of the purge control. When the detection value of the pressure sensor 43 is less than the second determination value JVb, the determination unit 45 determines that the electromagnetic valve 32 is not in the close failure state and thus judges the result of the primary determination is affirmative.

In the secondary determination, furthermore, as shown in FIG. 14, the determination unit 45 holds the purge valve 13 in the open state and turns the electromagnetic valve 32 and the switching valve 42 to the closed state. Then, the purge passage 12 is opened by the the purge valve 13 in the open state and the switching valve 42 is placed in the closed state, so that the pressure in the first region 34 and the pressure in the second region 35 of the canister 11 become negative due to the engine negative pressure. However, gas (i.e., purge air or purge gas) is allowed to flow little by little from the second region 35 to the first region 34 through the small hole 33, and therefore the second region 35 is made to gradually come under negative pressure. This causes a detection value of the pressure sensor 43 to gradually change to a negative value. If a time Tb required for the detection value of the pressure sensor 43 to reach a predetermined pressure Pb falls within a specified range, the determination unit 45 determines the the electromagnetic valve 32 is not in the close failure state and judges that the result of the secondary determination is affirmative.

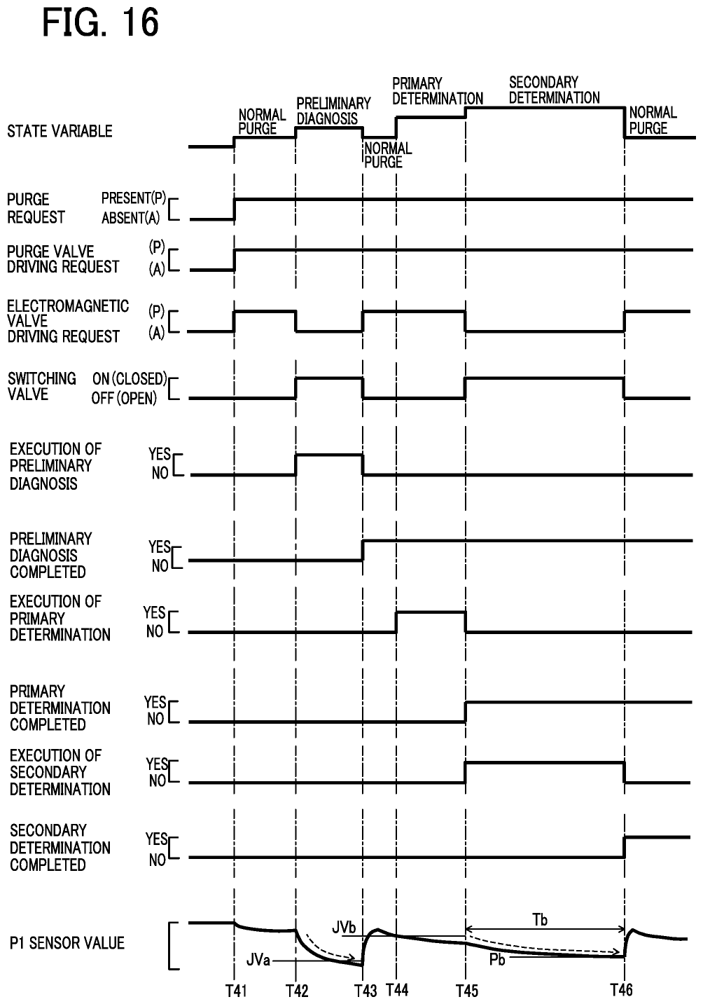

When the failure determination is executed as above, a time chart shown in FIG. 16 is carried out as one example. As shown in FIG. 16, when a purge request and a purge valve driving request are present at time T41, the purge valve 13 is turned to the open state and thus the purge control is started. At that time, when an electromagnetic valve driving request is present, the electromagnetic valve 32 is turned to the open state. The switching valve 42 remains open. Then, when the electromagnetic valve driving request is absent at time T42, the electromagnetic valve 32 is turned to the closed state. The switching valve 42 is also turned to the closed state. The preliminary diagnosis is thus performed. When the detection value of the pressure sensor 43 in this preliminary diagnosis becomes less than the first determination value JVa, the preliminary diagnosis is completed at time T43. At that time, the electromagnetic valve 32 and the switching valve 42 are turned to the open state.

Thereafter, the normal purge control is executed. At time T44, the primary determination is performed. When the detection value of the pressure sensor 43 in the primary determination is less than the second determination value JVb, the primary determination is completed and instead the secondary determination is started at time T45. At that time, the electromagnetic valve 32 and the switching valve 42 are turned to the closed state. In this secondary determination, it is determined whether or not the time Tb required for the detection value of the pressure sensor 43 to reach the predetermined pressure Pb falls within the specified range. At time T46, the secondary determination is completed.

### EXAMPLE 4

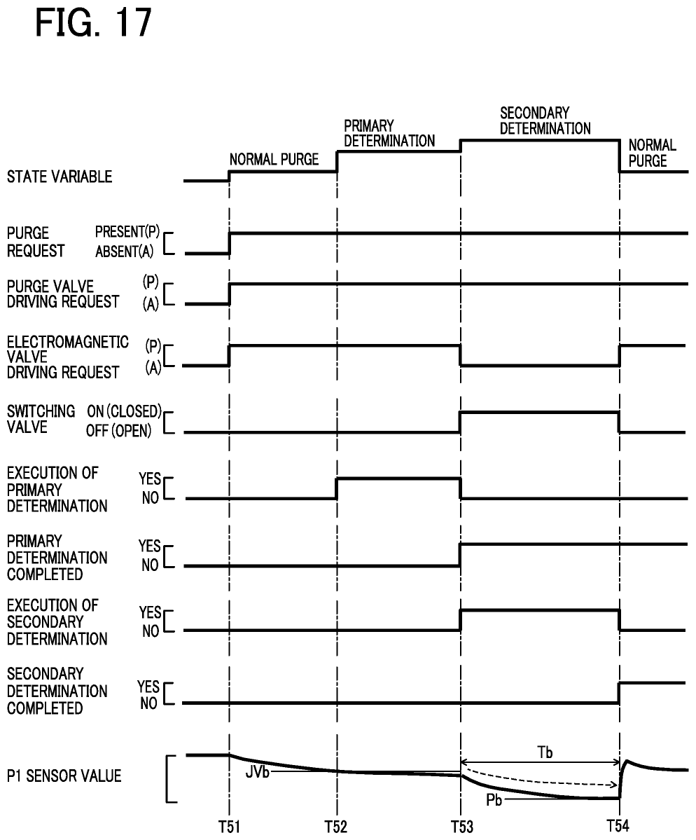

Example 4 will be described below. This Example exemplifies that execution of the preliminary diagnosis is unnecessary. Thus, differently from Example 3, the determination unit 45 in this Example is configured to perform the primary determination and the secondary determination as shown in FIGS. 11 and 17 without executing the preliminary diagnosis. The processing details to be carried out at time T51 to time T54 shown in FIG. 17 are the same as those to be carried out at time T43 to time T46 shown in FIG. 16 and therefore their description is omitted herein.

### EXAMPLE 5

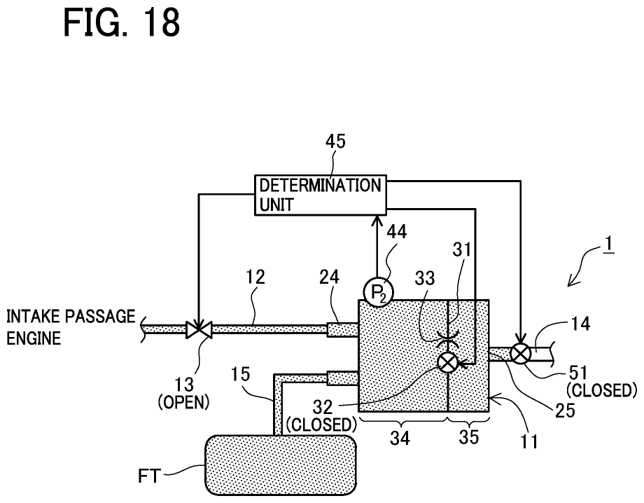

Example 5 will be described below. In this Example, as shown in FIG. 18, the evaporated fuel treatment apparatus 1 includes the pressure sensor 44 and a CCV (canister close valve) 51.

In this Example, the determination unit 45 is configured to perform the preliminary diagnosis, the primary determination, and the secondary determination as shown in FIG. 7, as with Example 1 and Example 3.

In the preliminary diagnosis in this example, the apparatus leak determination and the failure determination of the purge valve 13 and the CCV 51 are performed. Specifically, as shown in FIG. 18, during execution of the purge control, the determination unit 45 places the purge valve 13 in the open state and places the electromagnetic valve 32 and the CCV 51 in the closed state. When the detection value of the pressure sensor 44 is less than the first determination value JVa, the determination unit 45 determines that the purge valve 13 is not in the close failure state, the CCV 51 is not in the open failure, and further no apparatus leak has occurred, and thus judges that the result of the preliminary diagnosis is affirmative.

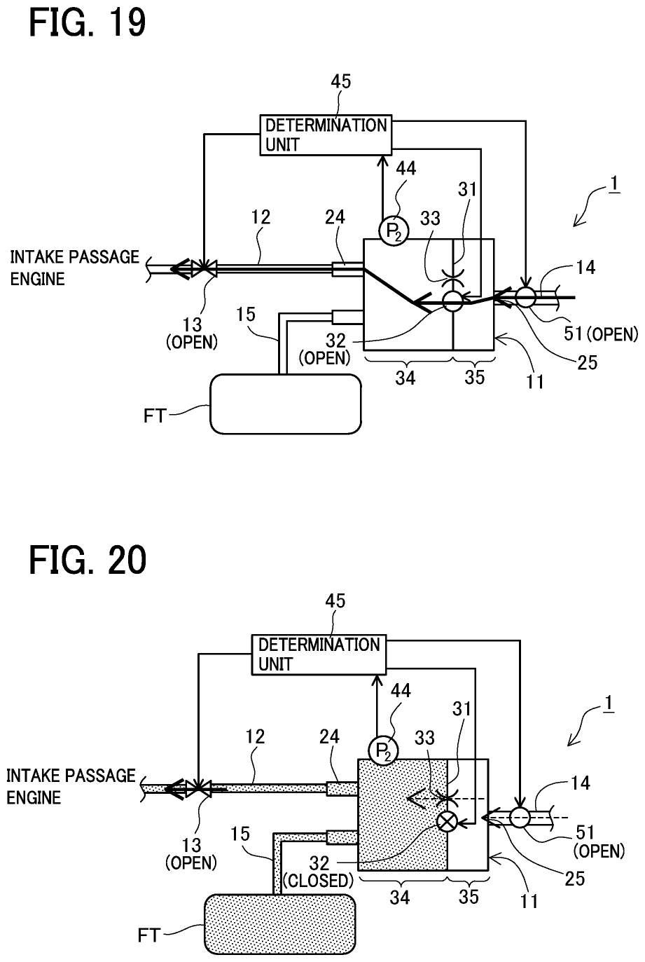

In the primary determination, the failure determination of the electromagnetic valve 32 is also performed. Specifically, as shown in FIG. 19, the determination unit 45 places all of the purge valve 13, the electromagnetic valve 32, and the CCV 51 in the open state during execution of the purge control. When the detection value of the pressure sensor 44 is less than the second determination value JVb, the determination unit 45 determines that the electromagnetic valve 32 is not in the close failure state and judges that the result of the primary determination is affirmative.

In the secondary determination, subsequently, the failure determination of the electromagnetic valve 32 is performed. Specifically, as shown in FIG. 20, the determination unit 45 holds the purge valve 13 in the open state, turns the electromagnetic valve 32 to the closed state, and holds the CCV 51 in the open state during execution of the purge control. Thus, the purge passage 12 is opened by the purge valve 13 in the open state and the electromagnetic valve 32 is placed in the closed state, so that the pressure in the first region 34 of the canister 11 becomes negative due to the engine negative pressure.

However, gas (i.e., purge air or purge gas) is allowed to flow little by little from the second region 35 to the first region 34 through the small hole 33, and therefore the first region 34 gradually comes under negative pressure. This causes the detection value of the pressure sensor 44 to gradually change to a negative value. If the time Ta required for the detection value of the pressure sensor 44 to reach the predetermined pressure Pa falls within the specified range, therefore, the determination unit 45 determines that the electromagnetic valve 32 is not in a close failure state and judges that the result of the secondary determination is affirmative.

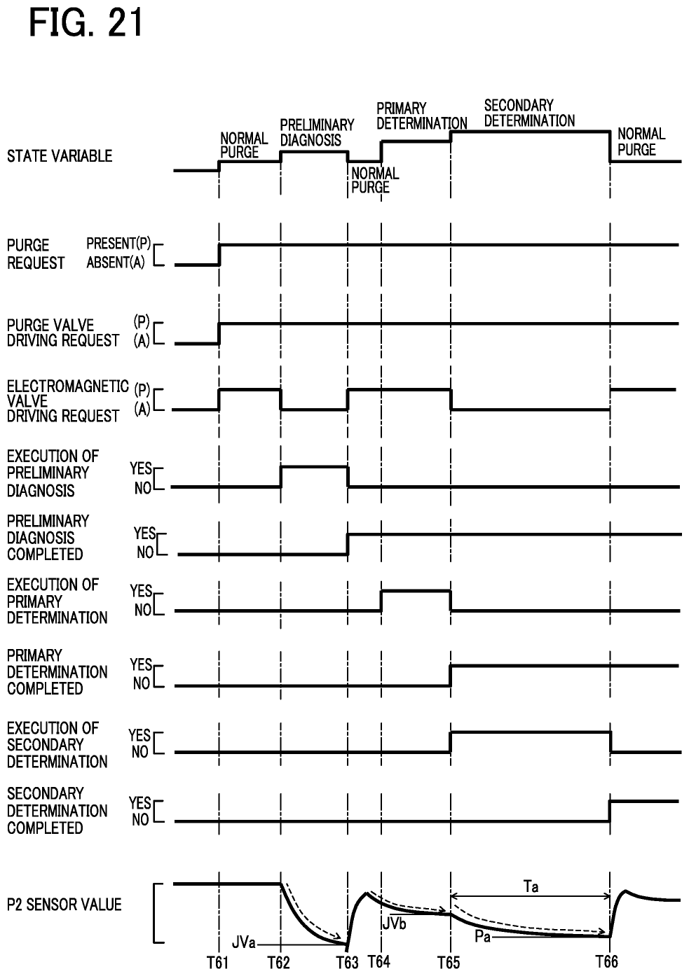

When the failure determination is executed as above, a time chart shown in FIG. 21 is carried out as one example. As shown in FIG. 21, when a purge request and a purge valve driving request are present at time T61, the purge valve 13 is turned to the open state and thus the purge control is started. At that time, when an electromagnetic valve driving request is present, the electromagnetic valve 32 is turned to the open state. The CCV 51 remains open. Then, when the electromagnetic valve driving request is absent at time T62, the electromagnetic valve 32 is turned to the closed state. The switching valve 42 is also turned to the closed state. The preliminary diagnosis is thus performed. When the detection value of the pressure sensor 44 (expressed by “P2 sensor value” in FIG. 21) in this preliminary diagnosis becomes less than the first determination value JVa, the preliminary diagnosis is completed at time T63. At that time, the electromagnetic valve 32 and the CCV 51 are turned to the open state.

Thereafter, the normal purge control is executed. At time T64, the primary determination is performed. When the detection value of the pressure sensor 44 in the primary determination is less than the second determination value JVb, the primary determination is completed and the secondary determination is started at time T65. At that time, the electromagnetic valve 32 is turned to the closed state. In this secondary determination, it is determined whether or not the time Ta required for the detection value of the pressure sensor 44 to reach the predetermined pressure Pa falls within the specified range. At time T66, the secondary determination is completed.

### EXAMPLE 6

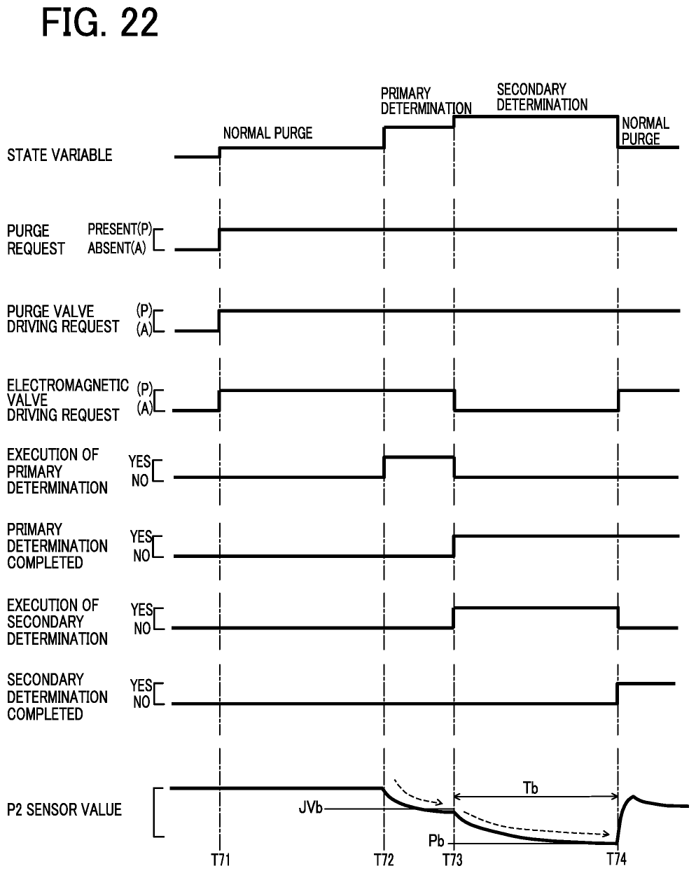

Example 6 will be described below. This Example exemplifies that execution of the preliminary diagnosis is unnecessary. Thus, differently from Example 5, the determination unit 45 in this Example is configured to perform the primary determination and the secondary determination as shown in FIGS. 11 and 22 without executing the preliminary diagnosis. The processing details to be carried out at time T71 to time T74 shown in FIG. 22 are the same as those to be carried out at time T63 to time T66 shown in FIG. 21 and therefore their description is omitted herein.

### <Operations and Effects of Present Embodiment>

The evaporated fuel treatment apparatus 1 in the present embodiment includes the partition wall 31, the electromagnetic valve 32, and the small hole 33, and further includes the determination unit 45 configured to perform the apparatus leak determination and the failure determination of the purge valve 13 and the electromagnetic valve 32 based on behaviors of the internal pressure of the canister 11 according to the opening and closing operations of the electromagnetic valve 32.

The evaporated fuel treatment apparatus 1 configured as above can address a request of a vehicle, such as the apparatus leak determination and the failure determination of the purge valve 13 and the electromagnetic valve 32, by use of the electromagnetic valve 32.

The electromagnetic valve 32 is an electrically-operated valve that is driven by a stepping motor. Accordingly, the electromagnetic valve 32 can be maintained in the open state at a predetermined opening degree without energization. This can save power and prevent heat generation.

### Third Embodiment

A third embodiment will be described below, in which similar or identical parts or elements to those in the first or second embodiment are assigned the same reference signs as those in the first or second embodiment and their details are omitted. The following description is made with a focus on differences from the first or second embodiment.

### EXAMPLE 1

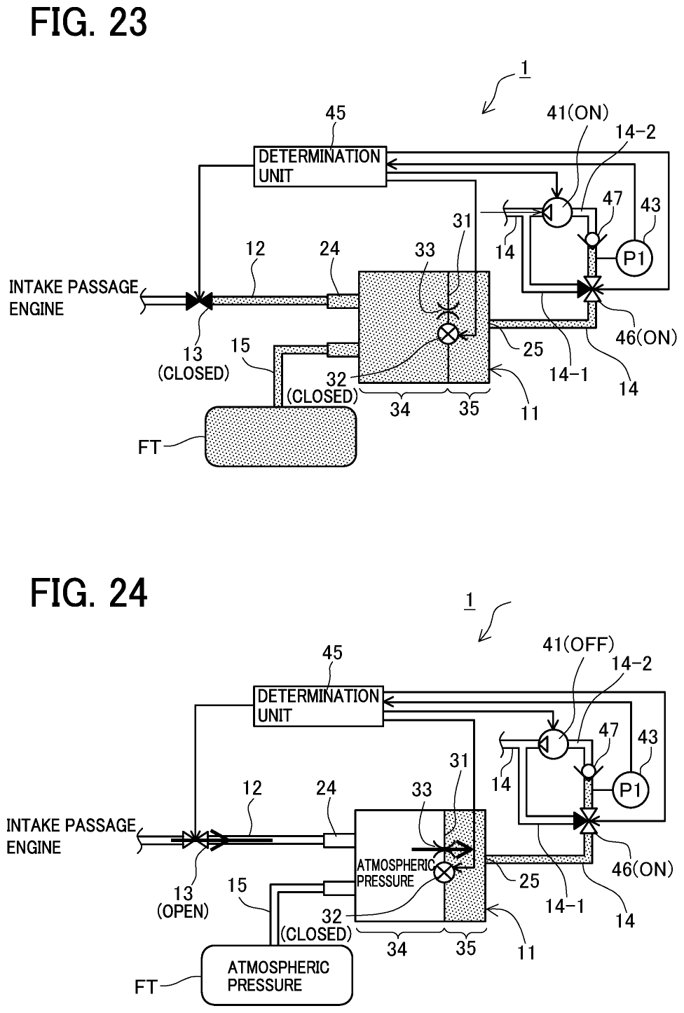

Example 1 will be described below. In this Example, as shown in FIG. 23, the evaporated fuel treatment apparatus 1 includes the kay-off pump 41, the pressure sensor 43, the determination unit 45, a switching valve 46, and a check valve 47. In the evaporated fuel treatment apparatus 1, a part of the atmosphere passage 14 branches into a first passage 14-1 and a second passage 14-2. These first passage 14-1 and second passage 14-2 are connected to the switching valve 46 that is a three-way valve. This switching valve 46 is configured to switch a passage to be communicated with the canister 11 between the first passage 14-1 and the second passage 14-2. In the second passage 14-2, the key-off pump 41, the check valve 47, and the pressure sensor 43 are arranged in order from a side far from the canister 11 toward a side close to the canister 11.

The determination unit 45 in this Example is configured to perform the failure determination of the electromagnetic valve 32 after executing the apparatus leak determination.

In the apparatus leak determination, as shown in FIG. 23, the determination unit 45 places the purge valve 13 and the electromagnetic valve 32 in the closed state and, in contrast, energizes the switching valve 46, i.e., turns the switching valve 46 to an ON state to allow the second passage 14-2 to communication with the canister 11 through the atmosphere passage 14, and also drives the key-off pump 41. Accordingly, gas (i.e., atmospheric air) is sucked by the key-off pump 41 into the second passage 14-2, generating a negative pressure in a downstream passage from the check valve 47 in the second passage 14-2 and others on the side close to the canister 11. At that time, when the detection value of the pressure sensor 43 is less than the first determination value JVa, the determination unit 45 determines that no apparatus leak has occurred.

In the failure determination of the electromagnetic valve 32, furthermore, as shown in FIG. 24, the determination unit 45 turns the purge valve 13 to the open state, holds the electromagnetic valve 32 in the closed state, continues to energize the switching valve 46, that is, holds the switching valve 46 in the ON state, and stops the key-off pump 41. In this configuration, gas gradually flows from the first region 34 under atmospheric pressure to the second region 35 under negative pressure, that is, under the pressure obtained during the leak determination, through the small hole 33, so that the pressure in the second region 35 gradually increases to the atmospheric pressure. Based on the behaviors of this pressure in the second region 35, the determination unit 45 determines whether or not the electromagnetic valve 32 is in the open failure state. If the time required for the pressure in the second region 35 to reach the atmospheric pressure falls within a predetermined normal range, the determination unit 45 determines that the electromagnetic valve 32 is not in the open failure state and also the small hole 33 is not in the close failure state.

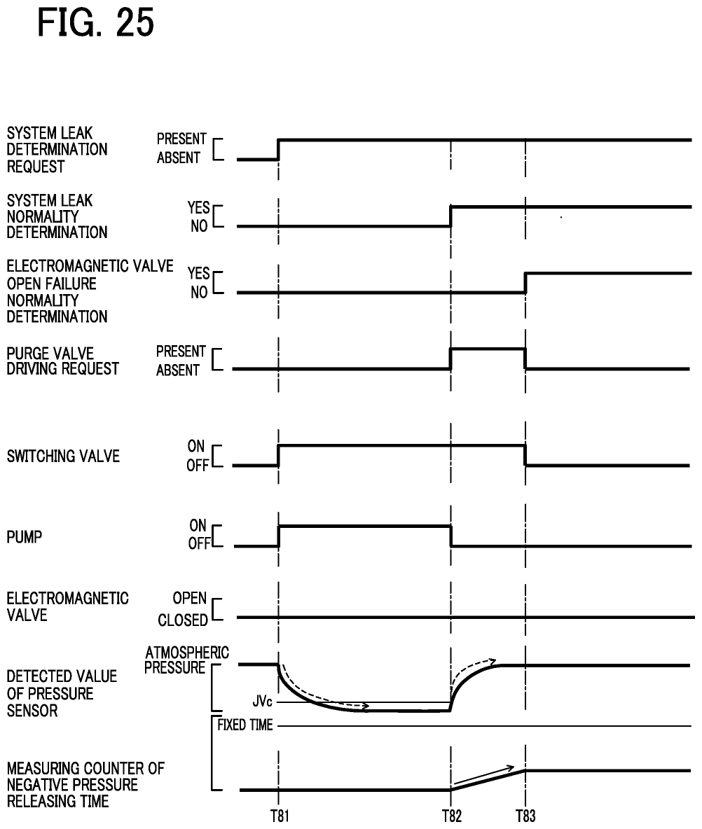

When the leak determination of the apparatus and the failure determination of the electromagnetic valve 32 are executed as above, a time chart shown in FIG. 25 is carried out as one example. As shown in FIG. 25, at time T81, a system leak determination request is present, the purge valve driving request is absent, causing the purge valve 13 to be held in the closed state, the switching valve 46 that is a three-way valve is energized, thus allowing the second passage 14-2 to connect to the canister 11, the electromagnetic valve 32 is in the closed state, and the key-off pump 41 starts to operate. Thus, the apparatus leak determination is started. In this apparatus leak determination, when a detection value of the pressure sensor 43 becomes less than a determination value JVc, at time T82, the determination unit 45 makes a system leak normality determination indicating that no apparatus leak has occurred and thus the evaporated fuel treatment apparatus 1 is normal. To perform the failure determination of the electromagnetic valve 32, furthermore, the purge valve driving request is made, turning the purge valve 13 to the open state. At that time, the switching valve 46 remains energized, the electromagnetic valve 32 remains closed, and the key-off pump 41 is stopped.

At time T83, when the detection value of the pressure sensor 43 becomes an atmospheric pressure, it is determined whether or not the electromagnetic valve 32 is in the open failure state and the small hole 33 is in the closed failure state based on the time length from time T82 to time T83, that is, the time required for the detection value of the pressure sensor 43 to reach the atmospheric pressure.

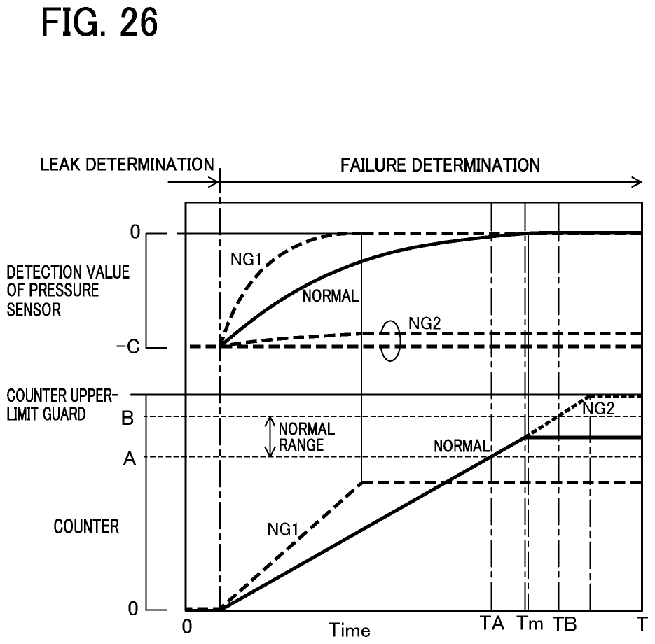

To be specific, as shown in FIG. 26, when a counter value that is counted as the time required for the detection value of the pressure sensor 43 to increase from a predetermined pressure, −C, i.e., the pressure (negative pressure) obtained during the leak determination, to 0, i.e., atmospheric pressure, falls within the normal range of A to B, this range being expressed as “Normal” in the figure, the determination unit 45 determines that the electromagnetic valve 32 is not in the open failure state and also the small hole 33 is not in the close failure state. In contrast, when the counter value is smaller than the normal range of A to B as indicated by “NG1” in the figure in which “NG” denotes no good, i.e., a failure, the determination unit 45 determines that the electromagnetic valve 32 is in the open failure state. When the counter value is larger than the normal range of A to B as indicated by “NG2” in the figure, the determination unit 45 determines that the small hole 33 is in the close failure state.

The normal range of the counter value, from A to B, is defined based on parameters (for example, a fuel remaining amount in the fuel tank FT, outside air temperature, atmospheric pressure, density, and the size of the canister 11) related to changes in the detection value of the pressure sensor 43.

The failure determination of the electromagnetic valve 32 is carried out as above based on the time required for the detection value of the pressure sensor 43 to increase from the negative pressure obtained during the apparatus leak determination to the atmospheric pressure. In the failure determination of the electromagnetic valve 32 to be performed after execution of the apparatus leak determination, specifically, the pressure in the second region 35 obtained during the apparatus leak determination is utilized. Accordingly, for execution of the apparatus leak determination and the failure determination of the electromagnetic valve 32, the components (i.e., the purge valve 13, the electromagnetic valve 32, the key-off pump 41, and the switching valve 46) are not individually driven for each determination, so that the number of times each component is driven is reduced. Furthermore, since the failure determination of the electromagnetic valve 32 is always performed after execution of the apparatus leak determination, the failure determination of the electromagnetic valve 32 can be carried out at a certain level of frequency.

### EXAMPLE 2

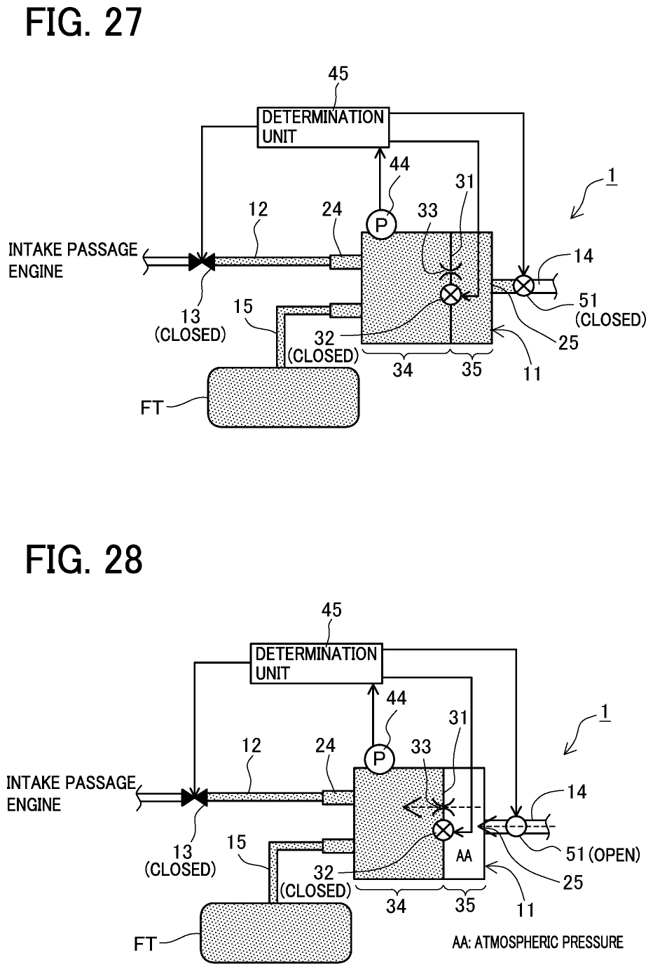

Example 2 will be described below. In this Example, as shown in FIG. 27, the evaporated fuel treatment apparatus 1 includes the pressure sensor 44 and the CCV 51.

In this Example, as in Example 1 described above, the determination unit 45 is configured to perform the failure determination of the electromagnetic valve 32 after executing the apparatus leak determination.

In the apparatus leak determination, as shown in FIG. 27, the determination unit 45 places all of the purge valve 13, the electromagnetic valve 32, and the CCV 51 in the closed state. When the detection value of the pressure sensor 44 is less than a determination value JVd, the determination unit 45 determines that no apparatus leak has occurred.

In the failure determination of the electromagnetic valve 32, furthermore, as shown in FIG. 28, the determination unit 45 holds the purge valve 13 and the electromagnetic valve 32 in the closed state and turns the CCV 51 to the open state. In this configuration, gas (i.e., purge air or purge gas) is allowed to flow little by little from the second region 35 under atmospheric pressure to the first region 34 under negative pressure, that is, under the pressure obtained during the leak determination, through the small hole 33, so that the pressure in the first region 34 gradually increases to the atmospheric pressure. Based on the behaviors of this pressure in the first region 34, the determination unit 45 determines whether or not the electromagnetic valve 32 is in the open failure state. If the time required for the pressure in the first region 34 to reach the atmospheric pressure falls within a predetermined normal range, the determination unit 45 determines that the electromagnetic valve 32 is not in the open failure state and also the small hole 33 is not in the close failure state.

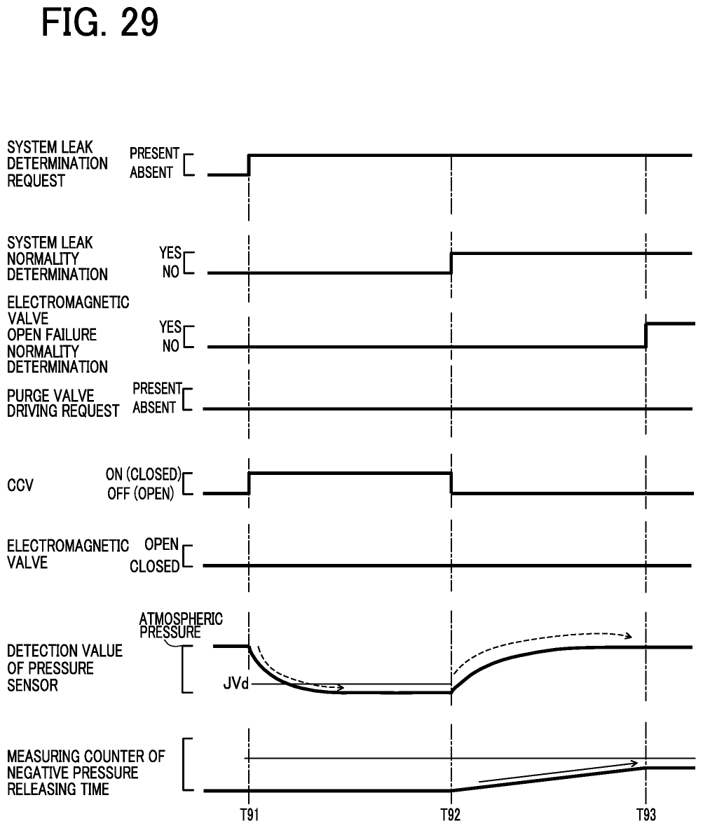

When the apparatus leak determination and the failure determination of the electromagnetic valve 32 are executed as above, a time chart shown in FIG. 29 is carried out as one example. As shown in FIG. 29, at time T91, a system leak determination request is present, the purge valve driving request is absent, causing the purge valve 13 to be held in the closed state, the CCV 51 that is a normally-open valve is energized and thus placed in the closed state, and the electromagnetic valve 32 is in the closed state. Thus, the apparatus leak determination is started. In this apparatus leak determination, when a detection value of the pressure sensor 44 becomes less than the determination value JVd, at time T92, the determination unit 45 makes a system leak normality determination indicating that no apparatus leak has occurred and thus the evaporated fuel treatment apparatus 1 is normal. To perform the failure determination of the electromagnetic valve 32, furthermore, the purge valve 13 remains closed, the CCV 51 is de-energized, i.e., turned to the open state, and the electromagnetic valve 32 remains closed.

At time T93, when the detection value of the pressure sensor 44 becomes an atmospheric pressure, it is determined whether or not the electromagnetic valve 32 is in the open failure state and the small hole 33 is in the closed failure state based on the time length from time T92 to time T93, that is, the time required for the detection value of the pressure sensor 44 to reach the atmospheric pressure.

The failure determination of the electromagnetic valve 32 is carried out as above based on the time required for the detection value of the pressure sensor 44 to increase from the negative pressure obtained during the apparatus leak determination to the atmospheric pressure. In the failure determination of the electromagnetic valve 32 to be performed after execution of the apparatus leak determination, specifically, the pressure in the first region 34 obtained during the apparatus leak determination is utilized. Accordingly, for execution of the apparatus leak determination and the failure determination of the electromagnetic valve 32, the components (i.e., the purge valve 13, the electromagnetic valve 32, and the CCV 51) are not individually driven for each determination, so that the number of times each component is driven is reduced. Furthermore, since the failure determination of the electromagnetic valve 32 is always performed after execution of the apparatus leak determination, the failure determination of the electromagnetic valve 32 can be carried out at a certain level of frequency.

### <Operations and Effects of Present Embodiment>

According to the present embodiment, the determination unit 45 is configured to perform the failure determination of the electromagnetic valve 32 after executing the apparatus leak determination. This can reduce the number of times each component is driven. The evaporated fuel treatment apparatus 1 in the present embodiment can have a certain level of frequency of performing the failure determination of the electromagnetic valve 32 without lowering the frequency.

### Fourth Embodiment

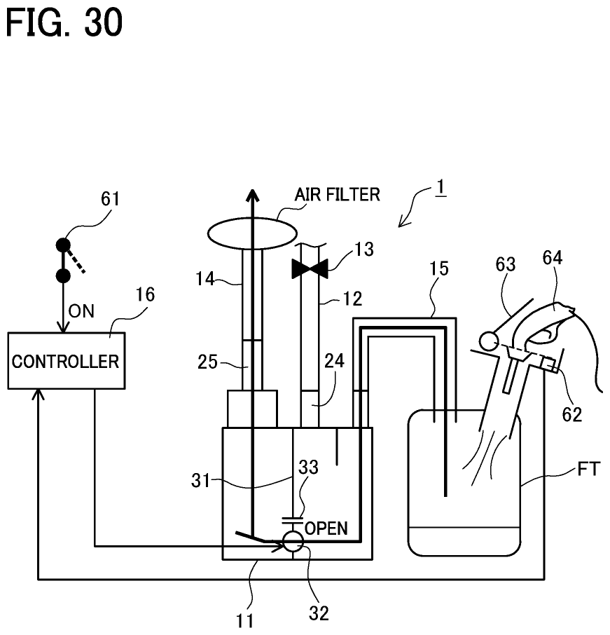

A next description will be given to the control to be performed by the controller 16 during refueling with respect to a vehicle provided with a refueling switch 61, a lid sensor 62, a refueling lid 63, and a refueling gun 64 as shown in FIG. 30.

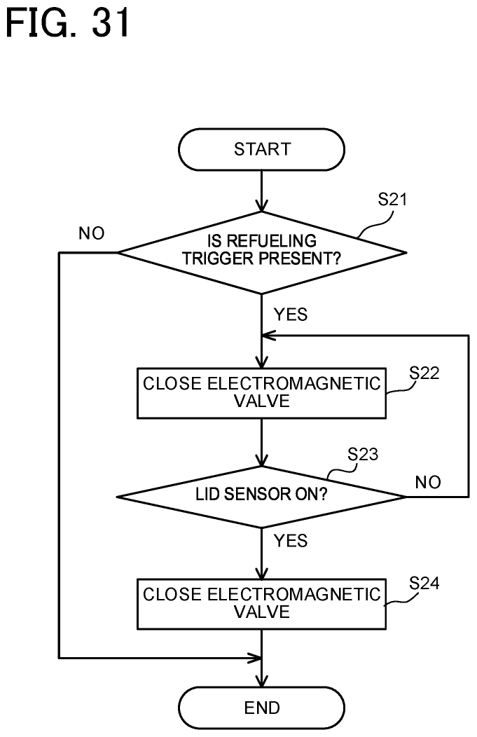

To be specific, when a refueling trigger is present (step S21: YES) as shown in FIG. 31, the controller 16 turns the electromagnetic valve 32 to the open state (step S22). This condition “when a refueling trigger is present” indicates the time when the refueling switch 61 is turned ON. Subsequently, when the refueling lid 63 is closed, turning the lid sensor 62 ON (step S23: YES), the controller 16 turns the electromagnetic valve 32 to the closed state (step S24).

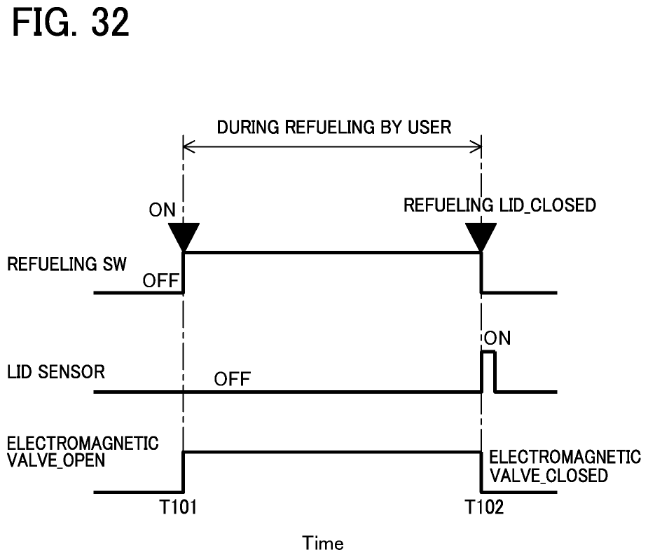

When the control is executed based on such a flowchart as shown in FIG. 31, a time chart shown in FIG. 32 is carried out as one example. As shown in FIG. 32, when the refueling switch 61 is turned ON at time T101, the electromagnetic valve 32 is turned to the open state. Thereafter, when the refueling lid 63 is closed and the refueling switch 61 is turned OFF at time T102, turning the lid sensor 62 ON, the electromagnetic valve 32 is turned to the closed state.

In the above manner, when detecting a refueling operation based on turn-on of the refueling switch 61, the controller 16 turns the electromagnetic valve 32 to the open state. Accordingly, the pressure in the fuel tank FT is allowed to escape through the canister 11 and the atmosphere passage 14 and thus does not excessively increase. Thus, the refueling gun 64 is prevented from automatically stopping before the fuel tank FT is not sufficiently supplied with fuel. Consequently, the fuel tank FT can be reliably filled with fuel during refueling. As an alternative, the controller 16 may be configured to detect the refueling operation based on any means other than the refueling switch 61.

The foregoing embodiments are mere examples and give no limitation to the present disclosure. The present disclosure may be embodied in other specific forms without departing from the essential characteristics thereof.

For instance, the activated carbon 22 is not limited to the two parts or layers as exemplified above but may be provided in three or more parts or layers. Further, the adsorbent may be any materials other than the activated carbon.

### REFERENCE SIGNS LIST

1 Evaporated fuel treatment apparatus
11 Canister
12 Purge passage
13 Purge valve
14 Atmosphere passage
14-a First passage
14-2 Second passage
15 Vapor passage
16 Controller
21 Canister case
22 Activated carbon
22-1 First-layer activated carbon
22-2 Second-layer activated carbon
23 Space chamber
24 Purge port
25 Atmosphere port
31 Partition wall
32 Electromagnetic valve
33 Small hole
34 First region
35 Second region
36 Relief valve
41 Key-off pump
42 Switching valve
43 Pressure sensor
44 Pressure sensor
45 Failure detection unit
46 Switching valve
47 Check valve
51 CCV
61 Refueling switch
62 Lid sensor
63 Refueling lid
64 Refueling gun
FT Fuel tank
Pa, Pb Predetermined pressure
Ta, Tb Time
JVa First determination value
JVb Second determination value
JVc, JVd Determination value

What is claimed is:

1. An evaporated fuel treatment apparatus comprising:
a canister connected to a fuel tank and provided with a plurality of adsorption layers for adsorbing evaporated fuel generated in the fuel tank;
a purge passage configured to allow purge gas containing the evaporated fuel to flow from the canister to an engine;
a purge valve configured to open and close the purge passage;
an atmosphere passage configured to take atmospheric air into the canister;
a controller configured to perform purge control by placing the purge valve in an open state to introduce the purge gas from the canister into the engine through the purge passage;
a partition wall dividing an inside of the canister into a first region located close to the purge passage and the fuel tank and a second region located close to the atmosphere passage;
an electromagnetic valve provided in the partition wall and configured to open and close between the first region and the second region;
a relief part provided in the partition wall and configured to release pressure between the first region and the second region; and
a determination unit configured to perform a leak determination of the apparatus and a failure determination of the purge valve and the electromagnetic valve based on behaviors of internal pressure of the canister according to an opening and closing operation of the electromagnetic valve.

2. The evaporated fuel treatment apparatus according to claim 1, wherein the electromagnetic valve is a valve that is in a closed state during non-energization.

3. The evaporated fuel treatment apparatus according to claim 1, wherein the electromagnetic valve is a valve that is driven by a stepping motor.

4. The evaporated fuel treatment apparatus according to claim 1, wherein the relief part is a fixed aperture having a fixed aperture opening degree.

5. The evaporated fuel treatment apparatus according to claim 1, wherein the relief part is a relief valve.

6. The evaporated fuel treatment apparatus according to claim 1, wherein the determination unit is configured to perform the failure determination of the electromagnetic valve after executing the leak determination.

7. The evaporated fuel treatment apparatus according to claim 1 further comprising a purge predicting part configured to:
predict a timing for performing the purge control based on vehicle information; and
place the electromagnetic valve in an open state at a time earlier by a predetermined time than the timing predicted by the purge predicting part.
